(19) United States
(12) Patent Application Publication
(10) Pub. No.: US 2011/0056402 A1
(43) Pub. Date: Mar. 10, 2011

(54) PLASMA GENERATOR FOR AN ELECTROTHERMAL-CHEMICAL WEAPONS SYSTEM COMPRISING CERAMIC, METHOD OF FIXING THE CERAMIC IN THE PLASMA GENERATOR AND AMMUNITION ROUND COMPRISING SUCH A PLASMA GENERATOR

(75) Inventors: Lennart Gustavsson, Karlskoga (SE); Ola Stark, Hammaro (SE)

(73) Assignee: BAE Systems Bofors AB, Karlskoga (SE)

(21) Appl. No.: 12/934,147

(22) PCT Filed: Mar. 23, 2009
(86) PCT No.: PCT/SE2009/000148

§ 371 Date: Nov. 18, 2010

(30) Foreign Application Priority Data
Apr. 1, 2008 (SE) 0800730-4

(51) Int. Cl. F42B 5/02; B23P 11/02

(52) U.S. Cl. 102/440; 29/447

(57) ABSTRACT

The invention relates to a plasma generator (4) for electrothermal and electrothermal-chemical weapons systems, the plasma generator being intended, via at least one emitted energy pulse, to form a plasma, which is designed to accelerate a projectile (3) along the barrel (11) of the weapons system in question, the plasma generator comprising a combustion chamber (20) having an axial combustion chamber channel (20′) and a ceramic arranged inside the combustion chamber channel for insulating the combustion chamber. According to the invention the ceramic consists of a shrink- fixed, compressively pre-stressed ceramic tube (23). The invention also relates to a method for shrink-fixing the ceramic tube in the combustion chamber channel as well as an ammunition round comprising a plasma generator according to the invention.

### FIELD OF THE INVENTION

The present invention relates to a plasma generator for electrothermal and electrothermal-chemical weapons systems, the plasma generator being intended, via at least one emitted energy pulse, to form a plasma, which is designed to accelerate a projectile along the barrel of the weapons system in question, the plasma generator comprising a combustion chamber having an axial combustion chamber channel and a ceramic arranged inside the combustion chamber channel for insulating the combustion chamber.

The present invention also relates to a method of fixing a ceramic in a plasma generator for electro-thermal and electrothermal-chemical weapons systems, the plasma generator being intended, via at least one emitted energy pulse, to form a plasma, which accelerates a projectile along the barrel of the weapons system in question, the plasma generator comprising a combustion chamber having an axial combustion chamber channel and a ceramic arranged inside the combustion chamber channel for insulating the combustion chamber.

The invention also relates to an ammunition round comprising a plasma generator for electrothermal and electrothermal-chemical weapons systems, the plasma generator being intended, via at least one emitted energy pulse, to form a plasma, which is designed to accelerate a projectile along the barrel of the weapons system in question, the plasma generator comprising a combustion chamber having an axial combustion chamber channel and a ceramic arranged inside the combustion chamber channel for insulating the combustion chamber.

### BACKGROUND OF THE INVENTION AND STATE OF THE ART

In a conventional barreled weapon, that is to say in this case a weapon which comprises a barrel and in which weapon a projectile is fired and propelled along the barrel by a propellant charge, which is ignited by means of a primer screw/primer cartridge as, for example, in artillery pieces, in tank and other combat vehicle canon, in anti-aircraft guns etc., a higher initial velocity (V₀) achieved for the projectile can be used, for example, to increase the range of the weapon, to improve the penetration capability of the projectile or to reduce a projectile trajectory time lapse, thereby making it easier to engage targets performing evasive maneuvers. The term primer screw relates to an ignition device, which ignites the propellant charge either mechanically or electrically. The term initial velocity (V₀) is here taken to mean the velocity of the barrel projectile as it leaves the barrel muzzle of the weapon, hereinafter therefore also referred to as the muzzle velocity (V₀) of the weapon. The term propellant charge relates to a deflagrating compound or a deflagrating substance, hereinafter called a propellant, such as a gunpowder, for example, in the form of a charge, which on combustion gives off propellant gases, which form a powerful gas excess pressure inside the barrel, which pushes the projectile forwards towards the muzzle of the barrel. The greater the gas excess pressure and the longer this gas excess pressure continues to act on the barrel projectile, the higher the muzzle velocity can become.

Great efforts have been made and continue to be made to achieve such an ever greater muzzle velocity (V₀) for all barrel projectiles regardless of type, in order to further improve said advantageous parameters. For example, the muzzle velocity (V₀) can be increased by increasing the size of the propellant charge of each ammunition round, so that a greater quantity of energy can thereby be utilized for propelling the projectile. The increase in velocity which is thereby feasible is nevertheless relatively limited. One reason for the limited increase in velocity is that an extra quantity of propellant charge supplied, including the propellant gases formed thereby, also has to be accelerated together with the projectile, so that a proportion of the energy from the extra quantity of propellant charge supplied is needed for this purpose, whilst all the propellant charge that is unburned when the projectile leaves the barrel does not provide any increase in velocity, since the gas excess pressure falls to the ambient atmospheric pressure as soon as the projectile leaves the barrel. It can also be a problem to fill conventional ammunition rounds with all the quantity of propellant charge that is required in order to achieve the desired muzzle velocity, and at the same time to find space for the actual projectile without greatly increasing the total weight of the ammunition round. If the propellant charge accommodated inside the ammunition round does not have a burning time that corresponds to the length of the barrel, the maximum velocity of the projectile may consequently be already attained before the projectile has left the barrel, since the propellant charge will have time to burn out before then.

Regardless of the size of the propellant charge and the propelling velocity achieved by the propellant charge, the optimum propellant charge must therefore burn as rapidly as the time taken to propel the projectile out of the barrel, which is why one factor limiting the maximum size of the propellant charge is the barrel length of the weapon. At the same time it will be obvious that the longer the barrel is, the heavier and more unwieldy the weapon becomes, so that the desired maneuverability of the weapon and the total weight of the weapon in turn determine the optimum barrel length and the thickness of the barrel material. Together with the material characteristics of this material in terms, for example, of its compressive strength, fatigue strength, wear etc., the material thickness of the barrel gives the maximum permitted barrel pressure Pₘₐₓ.

In order to prevent the gas excess pressure becoming so great that the barrel is damaged, i.e. that the maximum permitted barrel pressure is exceeded, which in the worst case could mean that the barrel bursts, the capacity of the propellant charge to generate propellant gas during the actual ignition of the propellant charge and at the beginning of the propulsion of the projectile through the barrel must therefore be kept at a relatively low level, so that the volume of propellant gas initially generated is small, compared to the total volume of gas that will have been generated when the propellant charge has burned out when the projectile leaves the muzzle of the barrel.

In order to compensate for an ever-increasing space inside the barrel behind the projectile accelerated by the propellant gases, and to prevent an unwanted fall in pressure, which would otherwise occur due to the increasing space, and which would occur unless the gas pressure were maintained throughout at said maximum permitted barrel pressure, by a further accelerating gas formation as a result of the ever faster combustion of the propellant charge, the quantity of propellant gas generated per unit time must therefore increase very sharply throughout the entire propulsion through the barrel, so as to reach its maximum just before the projectile leaves the barrel (see example of pressure curves in FIG. 8).

Such an accelerating gas formation can be achieved through the use of various so-called progressive propellant charges, that is to say propellant charges which have a combustion sequence in which the propellant charge burns faster and faster towards the end of the combustion sequence, so that more and more propellant gas is formed ever more rapidly.

The propulsion velocity and acceleration of the projectile therefore increases in step with the acceleration of the combustion sequence and the gas formation, the maximum muzzle velocity (V₀) of the projectile for each particular barrel length being optimized if the gas pressure behind the projectile is the same as the maximum permitted barrel pressure Pₘₐₓ throughout the propulsion sequence through the barrel.

A pressure curve over time for an optimum combustion sequence should therefore present an almost immediate pressure rise to Pₘₐₓ, followed by a persistent plateau phase with a constant barrel pressure maintained at Pₘₐₓ throughout the whole time that the propellant charge is burning inside the barrel, that is to say said burning time of the propellant charge, before then dropping to zero immediately the projectile leaves the barrel. All of the propellant charge will then normally have been burnt up. However, certain types of shells may be equipped with so-called base-bleed units, where the shell is propelled for some distance further by means of a small propellant gas motor, even after the shell has left the barrel.

One known method of obtaining said progressive propellant charge is to use various types of propellant mixtures in the same propellant charge, in which more and more chemically progressive propellant is ignited and burned the further forward the projectile is propelled in the barrel, which then gives the desired ever more rapid combustion and accelerating propellant gas formation during the burning time available for the barrel length. The propellant charge can also be chemically surface-treated with so-called inhibitors, so that the combustion of the propellant charge initially proceeds more slowly until the surface treatment has burned up, following which the remainder, that is to say the untreated fraction of the propellant charge, burns freely, so that consequently a propellant charge, which initially is in fact more powerful than Pₘₐₓ, can be used.

Another known method of achieving a progressive propellant charge is to successively increase the free burning surface of the propellant charge during the actual combustion of the propellant charge through multiple perforation of the propellant charge or, if the propellant charge comprises multiple smaller charge units, through multiple perforation of the various charge units of the propellant charge with a larger number of burn channels, so that a so-called perforated propellant is obtained. These burn channels are arranged at predefined intervals from one another, with a certain depth into the propellant charge or passing right though it, with a certain defined cross section and arranged in certain patterns, so that by achieving combustion of the propellant charge in this way, not only from the outside of the propellant charge but also from the inside of the burn channels, it is possible to successively increase the exposed burn surface accessible for combustion. The burn surface inside the burn channels increases sharply, since the burn channels are successively widened as a result of the combustion. The greater the increase in the burn surface, the faster the combustion of the propellant charge and hence an ever greater so-called progressivity.

By varying the reciprocal spacing, the depth, cross section and pattern of said multiple perforation, in conjunction with said use of various inhibitors, attempts are made to control the acceleration of the propellant gas formation in a desired way conducive to the propulsion of the projectile and thus to ensure that the propellant charge manages to burn out within the desired burning time, that is to say just when the projectile leaves the muzzle of the barrel.

Despite the aforementioned efforts to improve the current, conventional methods of propulsion and the propellant charges used for this purpose, however, the practically feasible upper limit for the muzzle velocity in conventional barreled weapons, and also for the chemically progressive, inhibited and perforated propellants has been reached at approximately 1500-1800 m/s. This is due to the fact that the chemical progressivity of the currently known propellant charges has an upper limit, and because at present the multiple perforation of the constituent propellant charges cannot be performed with just the requisite fine distribution. Furthermore these measures, including said inhibition, are not all that easy to calculate and implement in advance, so that the desired pressure curve is always exactly the same every time for each type of propellant charge fired. It will be appreciated that there is a negative effect on the firing accuracy of the projectile if the muzzle velocity cannot always be determined beforehand for each round fired. The maximum muzzle velocity depends, however, on the weight of the projectile in question, so that the limits vary depending on the type of ammunition, the lower muzzle velocity here relating, for example, to 40 mm caliber flechette ammunition.

There is therefore a great desire to create new propulsion principles and new ammunition of a different type to the merely combustion gas-powered propulsion and ammunition described above, which propulsion principles and new ammunition will give the fired projectile the desired, considerably higher initial velocity, that is to say a velocity at the barrel outlet in the order of 1800-2500 m/s, depending on the type and caliber of ammunition, for an unmodified projectile and total weight of the ammunition in question. Said new ammunition relates, for example, to armor piercing flechette ammunition intended for various weapons systems comprising many different calibers.

Many such new propulsion principles are currently under development, aimed at producing said desired higher initial velocity for various types of projectiles. The main classification of these propulsion principles is based on whether the propulsion is gas powered, electrical driven or achieved by a combination of these two methods of propulsion.

Examples of said gas power are, on the one hand, where the propulsion is based on a conventional combustion gas power, but the projectile also has an accompanying additional propellant charge for also generating propellant gases outside the barrel, for example the aforementioned base bleed unit, and on the other where gases other than propellant gases, such as reactant or inert gases are used for gas power. The term inert gas here refers to a gas which normally does not take part in any chemical reaction occurring in the gas power.

Examples of electrical drive are substantially all-electrical rail or coil driven canon. A typical feature of these electrically powered weapons systems is that they are intended to use electromagnetic pulses for the propelling projectiles specially adapted for this purpose.

Examples of combinations of said two main principles for the propulsion of projectiles are represented on the one hand by electrothermal power (ET), in which the supply of electrical energy to a small, tubular combustion chamber produces a material ablation from the inside of the combustion chamber, which possibly in conjunction with said inert and/or energetic gas forms a very hot, electrically conductive plasma and hence a large excess pressure for propelling the projectile, and on the other by electrothermal-chemical power (ETC), see for example U.S. Pat. No. 7,073,447, in which the chemical energy from the combustion of the propellant charge occurring in this case is used in conjunction with the further electrothermal energy supplied in the manner above.

When a substance has been heated up to the plasma state, the constituent parts of the molecules separate, that is to say part molecules or electrons of the substance move freely in relation to one another, and the core of the substance, so that both positive and negative and hence electrically conductive ions/charges are formed. Somewhat summarized, it may be said that an ETC weapon consists of an at least partially propellant gas-powered weapon, in which the total propulsion energy of the projectile receives an at least somewhat substantial energy boost through the supply of additional electrical energy from a high-voltage source via the plasma formed inside the combustion chamber. A propellant gas-powered cannon, which is only fired by means of an electrical heat ignition of the propellant charge, does not therefore constitute and ETC cannon.

In the hitherto known electrothermal-chemical weapons systems, the conventional primer screw is replaced by a plasma generator comprising said combustion chamber. One immediate advantage is that the timing of ignition becomes more precise compared to the conventional primer screw, where the ignition reaction time varies. The plasma generators can be divided into two different main types, of which the one type, referred to below as a plasma jet burner, delivers a single axial plasma jet from the free end orifice of the plasma jet burner, whilst the second type comprises a radially multi-perforated tube, similar to a flute and therefore also referred to as a ‘piccolo’, having multiple openings for the plasma arranged along the circumferential surface of the tube. The ‘piccolo’ normally lacks an end orifice opening, so that compared to the plasma jet burner, it is not possible to generate the same powerful plasma jet directed forwards in the longitudinal direction of the plasma jet burner. Both types of plasma generator comprise an electrically conductive conductor for forming the plasma, the electrically conductive conductor being heated up, gasified and ionized by way of a very strong, short pulse of electrical energy, so that the plasma produced flows out through the openings in the tube, or the end orifice opening of the plasma jet burner, at a very high pressure and temperature, normally several hundred MPa, preferably in the order of about 500 MPa, the temperatures varying between a high to extremely high temperature, that is to say normally approximately 3,000° K-50,000° K, where 3,000° K represents the temperatures reached in the conventional chemical propellant charges. The plasma temperatures are preferably between approximately 10,000° K and 30,000° K, however.

The very high temperature of the plasma has several positive effects on the combustion of the propellant charge. For example, at said plasma temperatures a much more complete combustion of the propellant charge propellant is obtained, compared to the considerably lower temperatures normal in conventional combustion. This is because the propellants are to a greater extent converted into plasma, since the propellants are split into smaller molecules, with the result that more energy is extracted from the same quantity of propellant charge. This increased quantity of energy thereby affords the desired further increase in the muzzle velocity of the projectile.

Since the propellant charge also burns faster at the higher temperature of the plasma, a larger propellant charge is burned before the projectile leaves the barrel, so that if the cartridge case has room for this, the quantity of propellant charge can be increased for each given round of ammunition, thereby affording a further increase in the amount of energy for boosting the muzzle velocity. Specially produced types of propellant with a greater density, higher energy content and lower molecular weight of the propellant gases, which cannot normally be used or which cannot be ignited by conventional primer screws, may be used.

Owing to the very high temperature and also the very high internal pressure inside the plasma generator, the combustion chamber of the plasma generator and also the barrel will be exposed to very great thermal and load stresses. These stresses vary directly as a function of the pulse length and amplitude of the electrical energy, a long pulse length, that is to say the time interval for which the electrical energy pulse lasts, generating more heat and greater stresses than a short pulse length. The long pulse length is advantageous, however, with regard to the larger quantity of energy delivered for acceleration of the projectile, so that one solution to this heat problem is to provide the channel walls of the combustion chamber with an internal, highly heat-resistant insulating material, for example a ceramic which is also electrically insulating. Using ceramic layers or inserts on the inside of a barrel and at various positions in the longitudinal direction of the barrel, in order to prevent the transmission of electrical energy from electrical igniters to the body of the barrel, is already known, although this involves solutions to problems altogether different from the prevention of thermal and load stresses inside plasma generators.

Nevertheless, U.S. Pat. No. 4,957,035, for example, shows an ET weapon comprising a multi-channel, conical ceramic plasma jet burner firmly screwed into the breech of the ET weapon, wherein an arc is generated between a rear central electrode and a front annular electrode in each ceramic combustion chamber channel. A very hot plasma at high pressure is thereby generated in the combustion chamber channels connected to the barrel, said pressure driving the projectile located in the barrel out of the barrel. The highly heat-resistant and electrically insulating ceramic walls of the combustion chamber channels afford protection against the extreme heat and electrically isolate the two electrodes from one another and the combustion chamber channel from the rest of the plasma jet burner.

The ceramics characteristically have a relatively good compressive strength but otherwise have a low strength. In particular, the ceramics have a low tensile strength. The very high internal pressure, in the order of approximately 500 MPa, inside the ceramic-lined combustion chamber channels caused by the hot plasma results in an expansion of the ceramic against the walls of the combustion chamber channels. If there happens to be any degree of loose play between the ceramic and the walls of the combustion chamber channels, or if the combustion chamber channels yield, that is to say expand in response to the pressure, tensile stresses are bound to occur in the ceramic. In the aforementioned plasma jet burner in U.S. Pat. No. 4,957,035, these tensile stresses would easily tear the ceramic apart and cause serious leakage of heat, current, voltage and/or plasma, resulting in inevitable damage to the weapon, if the strength of the plasma jet burner were not mechanically improved by way of the axial force with which the conical plasma jet burner is screwed firmly into a corresponding conical and inflexible space and thereby clamped down. Mechanically pressing the plasma jet burner into the conical space in this way is intended as an attempt to counteract, at least to some degree, said tensile stresses in the ceramic, which has, however, not been altogether successful.

In another embodiment shown, attempts have been made to reinforce and seal the plasma jet burner further by wrapping glass fiber-reinforced plastic around the outside thereof. Despite these measures, this conical screw fixing still gives an unsatisfactory result. In particular the problems remain of play between the ceramic and the walls of the combustion chamber channels, caused by material irregularities and tolerance defects, and the fact that the interacting conical parts have to be manufactured very accurately in order to fit one another without play, which makes the parts expensive to manufacture.

It will also be appreciated that the conical shape means that the design has created something basically most akin to a champagne cork, which is just waiting for the internal pressure to increase before the whole design construction explodes.

The conical screw fixing is therefore a production engineering method that represents an expensive, time-consuming and complicated way of solving the problems of tensile stresses in the ceramic. The aforementioned negative parameters are further compounded in the second embodiment shown by the outer glass fiber-reinforced plastic wrapping, which can best be compared to a further emergency measure taken in a laboratory setup.

Furthermore, already with just somewhat longer pulse lengths of a few milliseconds, such extremely high temperatures occur that the plasma generator runs the risk of being damaged despite the ceramic. At the same time there is a desire for a facility for accurately controlling, by way of a long-lasting plasma, the combustion of the propellant charge and the electrical energy delivered to the propellant gases. The aforementioned conical design rapidly begins to leak, making it unusable, so that the design constitutes a single-use weapon.

In order to be able to accurately control the supply of electrical energy and thereby to further increase the muzzle velocity of an ETC weapon, there is therefore a great desire to find a reliable way, in a combustion chamber channel of a plasma generator electrically insulated by ceramics, both of ensuring the plasma generation and greatly increasing the pulse length, most preferably at least tenfold compared to hitherto feasible pulse lengths, whilst not allowing the plasma generation and the longer pulse length to crack the ceramic, and without the design construction becoming expensive or unduly complicated.

A further major problem with the conventional ETC weapons is that they use the barrel as opposite electrode, so that these design constructions also render the actual barrel and hence other major parts of the weapons system in question live. Apart from obvious disadvantages to this, such as the risk of personal injury due to the electric electrical hazard and short-circuiting of the weapons system, it will be appreciated that there is a serious risk of a metal cartridge case being welded fast in the barrel when current and voltage are transmitted to the weapon. Moreover, sensitive electronic equipment may be damaged by unwanted electrical transmissions and resulting magnetic fields.

The patent specification U.S. Pat. No. 6,186,040 describes a known plasma jet burner for electrothermal and electrothermal-chemical cannon systems, in which the requisite current and voltage are transmitted to the plasma jet burner via its rear part and then to the actual barrel. In one of the embodiments shown, said metal cartridge case is instead made of a non-conductive material, but when the barrel is used as opposite electrode the barrel will still be carrying current and in this case there will be a risk of the cartridge case fusing tight.

A further serious effect of the design construction shown is that the bearing surface between the electrical contact device of the weapon located in the breech and the corresponding contact device of the plasma jet burner is minimal, so that the weapon recoil and other vibrations when the weapon is in use cause a slight play between said contact devices and an arc can occur which welds the contact devices fast to one another. The entire weapon therefore risks becoming a single-use weapon, which can only be fired one single time.

### SUMMARY OF THE INVENTION

An object of the present invention and various embodiments thereof is to provide a substantially improved plasma generator for electrothermal and electrothermal-chemical weapons systems and a method of fixing a ceramic in such a plasma generator, the plasma generator and the method substantially reducing or completely eliminating the aforementioned problems and especially the problems associated with the strength of the ceramic in the combustion chamber channels.

A further object of the present invention and various embodiments thereof is to provide a substantially improved plasma generator for electrothermal and electrothermal-chemical weapons systems and a method of fixing a ceramic in such a plasma generator, the plasma generator and the method being capable of achieving considerably longer pulse lengths and plasma life spans without such extremely high temperatures and pressures occurring that the plasma generator and its ceramic being at risk of sustaining damage.

Another object of the present invention and various embodiments thereof is to provide a substantially improved plasma generator for electrothermal and electrothermal-chemical weapons systems, the plasma generator substantially reducing or completely eliminating the problems associated with the barrel being rendered live etc., or the electrical current finding its way through the construction, resulting in short circuits and the cartridge case being burned fast in said barrel.

Said objects and other aims not enumerated here are satisfactorily achieved within the scope of the specifications in the present patent claims.

According to the present invention therefore, an improved plasma generator has been provided for ammunition rounds for electrothermal and electrothermal-chemical weapons systems, which is characterized in that the ceramic consists of a shrink-fixed, compressively pre-stressed ceramic tube for producing a compressive pre-stressing of the ceramic tube predefined by the shrink-fixing.

According to further aspects of a plasma generator according to the invention:

the inside diameter of the combustion chamber is smaller than the outside diameter of the ceramic tube when the combustion chamber and the ceramic tube are at the same temperature.

a sealing material is located between the ceramic tube and the walls of the combustion chamber channel for sealing, load compensation and evening out all material irregularities, tolerance defects and other deviations in diameter occurring between the ceramic tube and the walls of the combustion chamber channel.

the ceramic tube has a compressive pre-stressing which is greater than the tensile stresses occurring in the ceramic during plasma formation, or the compressive pre-stressing is at least equal to such a large proportion of the tensile stresses that occur in the ceramic tube during formation of said plasma by the plasma generator that the highest tensile stresses resulting in the ceramic tube are lower than the maximum permitted tensile stress for the ceramic tube.

the ceramic tube is shrink-fixed with a compressive pre-stressing in the order of 300 MPa-1000 MPa, preferably 500 MPa-700 MPa.

the ceramic tube has a heat resistance which will withstand a top temperature of up to at least approximately 50,000° K and an operating temperature of between approximately 10,000° and 30,000° K, where the operating temperature acts at least during the time that the plasma is being maintained or created via fresh energy pulses.

the ceramic tube has a heat resistance which will withstand temperatures up to at least approximately 10,000°-30,000° K at least throughout the time the projectile is being propelled through the barrel.

the ceramic tube comprises one or more ceramic materials, preferably of titanium oxide, zirconium dioxide, aluminum oxide or silicon nitride or the like.

the plasma generator has an electrically conductive central electrode arranged inside the ceramic tube between the front end and the rear end of the combustion chamber, the central electrode comprising an electrically conductive central contact device, at least one electrical conductor and at least one gasifiable polymer sacrificial material, preferably containing hydrocarbons.

the sacrificial material consists of a tube, which is arranged along a defined part of the central electrode.

the sacrificial material tube is fixed to the ceramic tube by means of an adhesive.

the central contact device is fitted inside the rearmost part of the ceramic tube by shrink-fixing.

the outside diameter of the central contact device is greater than the inside diameter of the ceramic tube when the central contact device and the ceramic tube are at the same temperature.

at least one gasifiable polymer sacrificial material has a lower molecular mass than said electrical conductor, this minimum of one gasifiable polymer sacrificial material preferably having a molecular mass which is <30μ (30 g/mol).

the plasma generator comprises an axially arranged end orifice opening for delivering a single axial plasma jet out of the combustion chamber of the plasma generator.

the ceramic tube and the sacrificial material are axially fixed and axially clamped in the combustion chamber channel by a body comprising the end orifice opening.

the ceramic tube and the sacrificial material are axially fixed and axially clamped by the cylindrical body screwed tight against their front end surfaces with a certain defined force.

the plasma generator comprises multiple openings arranged radially along the circumferential surface of the combustion chamber for a radial emission of plasma jets from the combustion chamber of the plasma generator.

The improved method of fixing a ceramic in a plasma generator for electrothermal and electrothermal-chemical weapons systems according to the present invention is characterized in that a ceramic tube is fitted inside the combustion chamber by shrink-fixing, the metal combustion chamber being heated and thereby expanded so that an adequate tolerance is created between the combustion chamber and the ceramic tube, so that the ceramic tube can be fitted inside the combustion chamber, that the combustion chamber as it cools to the same temperature as the ceramic tube shrinks around the ceramic tube and encloses the ceramic tube, so that the ceramic tube is firmly seated along its outer surface against the inside of the combustion chamber channel, and that the ceramic tube thereby acquires a certain, defined compressive pre-stressing due to the shrinkage of the combustion chamber.

According to further aspects of a method according to the invention:

the ceramic tube is cooled before fitting in the combustion chamber channel.

the ceramic tube is compressively pre-stressed by the contraction of the enclosing combustion chamber as it shrinks, so that the tensile stresses later occurring in the ceramic during the plasma formation are less than the compressive pre-stressing or are counteracted to such a degree that the resulting stresses in the ceramic are lower than the maximum permitted tensile stresses for the ceramic.

a central contact device is cooled, preferably in nitrogen, to −196° C., and is fitted inside the ceramic tube, and the central contact device after it has returned to normal temperature is expanded to such a degree that the central contact device is fixed inside the ceramic tube.

The ammunition round according to the present invention is characterized in that it comprises a plasma generator according to the invention and that the plasma generator of the ammunition round is manufactured by a method according to the invention.

### ADVANTAGES AND EFFECTS OF THE INVENTION

The inevitably high plasma temperatures in the plasma generator make it necessary to protect the combustion chamber channel walls by introducing a highly heat-resistant ceramic insert or using such a material to line the combustion chamber channel walls. The ceramic is moreover significantly more impervious than a glass fiber insulation, for example, since glass fiber insulation allows the current to pass more readily through the space between the glass fiber threads.

Shrink-fixing the ceramic inside the combustion chamber channel according to the invention, so that the play, which would otherwise be formed between the ceramic and the walls of the combustion chamber channels by material irregularities and tolerance defects, is eliminated or at least greatly reduced, and so that the shrink-fixing causes the ceramic insert/inner lining/tube to be compressively pre-stressed by the contraction of the enclosing combustion chamber as it shrinks, to such a degree that the tensile stresses later occurring in the ceramic during the plasma formation are less than the compressive pre-stressing or are counteracted to such a degree that the resulting stresses in the ceramic are lower than the maximum permitted tensile stresses for the ceramic, is a satisfactory way of solving the problem of the ceramic readily braking apart under the very high tensile stresses that would otherwise occur in the ceramic during the formation of the plasma.

Since the shrink-fixed ceramic in the combustion chamber can cope with the plasma, which has an even higher temperature and thereby a higher pressure than was formerly possible, a more rapid and more complete propellant charge combustion is obtained, and is obtained moreover from more modern, higher-energy propellant charges, since the propellant in these more modern propellant charges cannot only be ignited, but can also be converted into yet smaller molecules than hitherto, with the result that more energy is extracted from the same quantity of propellant charge, so that the maximum possible muzzle velocity for the barreled weapon in question increases.

The shrink-fixing according to the invention means that the ceramic combustion chamber insert in the plasma generator in the form of the ceramic tube, withstands the vibrations that occur due partly to use of the weapon and its recoil, and partly as a result of said multiple energy and pressure pulses, which is something that existing ceramic plasma generators cannot withstand since the ceramic is not compressively pre-stressed. Furthermore, ceramic parts located in an ammunition round and a plasma generator, in the form of a ceramic tube, for example, may sustain damage during handling of these, so that a compressively pre-stressed and shrink-fixed ceramic tube reduces these handling risks.

### BRIEF DESCRIPTION OF THE DRAWINGS

The invention will be described in more detail below with reference to the drawings attached, in which:

FIG. 1 is a schematic, perspective view of an ammunition round for an electrothermal-chemical weapons system, the ammunition round comprising a plasma generator according to the present invention.

FIG. 2 is a schematic, longitudinal section through parts of the ammunition round according to FIG. 1, the ammunition round comprising the plasma generator, parts of a propellant charge and a projectile enclosed in a cartridge case.

FIG. 3 is a schematic, longitudinal section through parts of an electrothermal-chemical weapon according to a first embodiment, for firing the ammunition round according to FIG. 1 by means of a plasma generator according to FIG. 4.

FIG. 4 is a schematic, longitudinal section through parts of a plasma generator according to a first embodiment of the invention.

FIG. 5 is a schematic, perspective view of a turret of a combat vehicle, in which an electrothermal-chemical weapons system comprising a plasma generator according to the invention is used.

FIG. 6 shows a schematic, perspective view of an alternative cartridge case for use in the ammunition round comprising a plasma generator according to the invention.

FIG. 7 is a schematic, longitudinal section through the cartridge case according to FIG. 6.

FIG. 8 schematically shows pressure curves in a firing by a plasma generator according to the invention.

FIG. 9 shows a schematic, longitudinal section through parts of a second embodiment of the plasma generator according to the invention, comprising contact devices of laminated contact type.

FIG. 10 is a schematic, longitudinal section through parts of an electrothermal-chemical weapon according to a second embodiment, for firing an ammunition round by means of the plasma generator according to FIG. 9.

FIG. 11 is a schematic, cross section through parts of a plasma generator according to the invention, showing a corresponding half cross section of the concentrically arranged combustion chamber, the ceramic tube, the sacrificial material tube and the electrical conductors in the solidified plastic mass. The sacrificial material tube is also shown comprising several layers or, symbolically, the outer coats, one of which is burned off for each energy pulse.

### DETAILED DESCRIPTION OF THE EMBODIMENTS

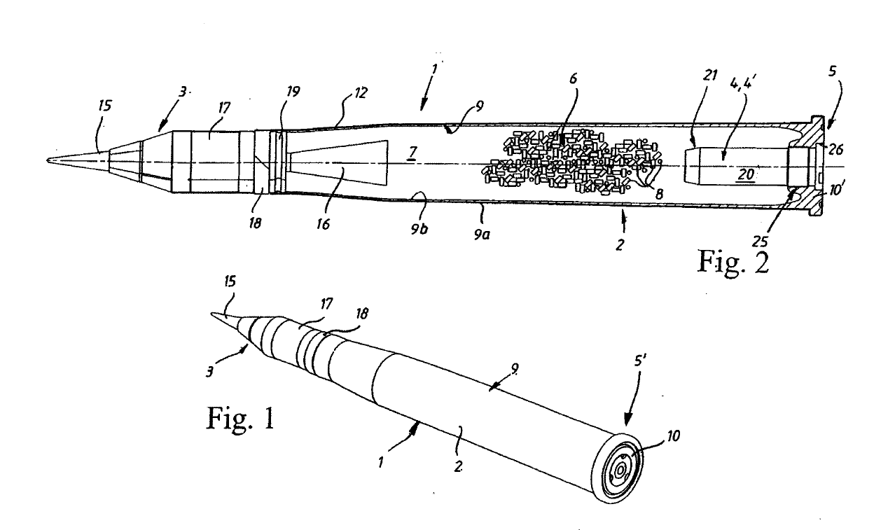

Referring to FIG. 1, this schematically shows a perspective view of an ammunition round 1 for an electrothermal-chemical (ETC) weapons system, which is therefore hereinafter also referred to as an ETC round, preferably comprising armor-piercing flechette ammunition for use in tanks, combat vehicles and various anti-tank weapons, for example, but also for use in combat aircraft, anti-aircraft weapons and other artillery, for example.

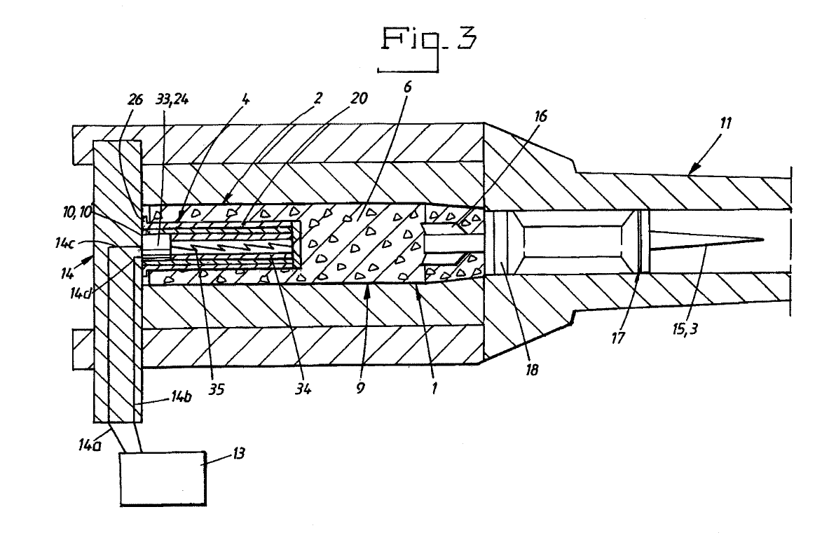

FIG. 2 shows a schematic, longitudinal section through parts of a first embodiment of the ammunition round 1 in FIG. 1, the ammunition round 1 comprising a cartridge case 2, a front projectile 3, a plasma generator 4 for forming a plasma according to the present invention, located at the rear end 5 of the ammunition round 1, and parts of a propellant charge 6 enclosed in the cartridge case 2. The propellant charge 6 is only indicated schematically in the middle of the cartridge case 2, but the entire cavity 7 of the cartridge case 2 is in fact preferably filled with the propellant charge 6.

The propellant charge 6 here consists of powder propellant, also referred to as propellant pellets 8, for example a compacted NC propellant powder charge. Said propellant pellets 8 have often been pretreated with a suitable chemical in order to create adhesion between the individual propellant pellets 8, following which the propellant pellets 8 are compressed to form the desired propellant charge 6 for the cartridge case in question, with a desired shape defined by the cavity 7.

The propellant charge 6 may also consist of a solid propellant (not shown) comprising at least one charge unit in the form of one or more cylindrical rods, disks, blocks etc., the charge units having multiple perforations with a larger number of burn channels, so that a so-called perforated propellant is obtained, and said charge unit or charge units together substantially packing or filling the internal dimensions of the cartridge case 2. Alternative embodiments of the propellant charge 6 also comprise multi-perforated double-base (DB) propellant with inhibitors, Fox 7, ADN, Nitramin, GAP with many known types of powder or a suitable liquid propellant (not shown).

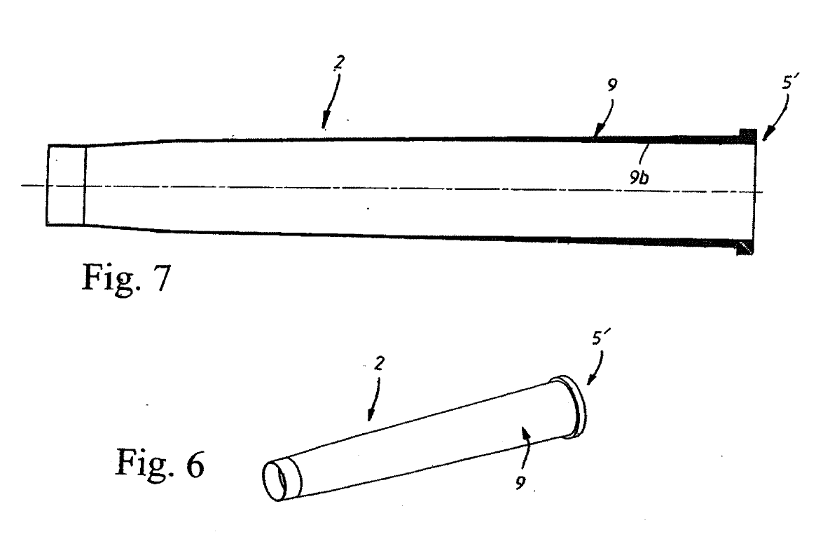

The outer casing 9 of the cartridge case 2, see FIGS. 2, 6 and 7, preferably consists of an electrically insulating material, that is to say dielectric or non-conductive, for example a fiber composite (see FIGS. 6 and 7), or the outer casing 9 contains a combination of various materials, in which at least an outer coating 9a and/or an inner coating 9b or surface are electrically insulating (see FIG. 2).

In the embodiment of the cartridge case 2 shown in FIG. 2, this comprises a metal outer casing 9 on which a plastic forming a thicker outer coating 9a and a thinner inner surface 9b have been applied for electrical insulation of the outside and inside respectively of the outer casing 9 in relation to at least the barrel 11 of the weapons system, see in particular FIG. 3, and preferably also in relation to the plasma generator 4. In the manufacture of such a cartridge case 2, the outer casing 9, for example, may consist of a conventional metal casing on which a plastic is made to adhere by a vapor deposition technique, so that an outer and/or inner protective plastic film coating with a thickness of approximately 20-70μ is formed. The thicker outer coating 9a may also consist of an outer shrink tube 12, which has been applied over the outer casing 9, the outer dielectric layer 9a or directly on top of the propellant charge 6. In the embodiment shown in FIG. 2 the cartridge case 2 also comprises a base 10′ with is integrally formed with the rest of the outer casing 9 of the cartridge case 2, that is to say made out of and from the same material as the rest of the outer casing 9. It will be appreciated that said material may also be an inherently electrically insulating material.

In the embodiment of an electrically insulating outer casing 9 shown in FIGS. 6 and 7, this consists here of a stiff, wound, fiber-reinforced thermosetting plastic, for example an expoxy plastic, cured polyethylene etc., having the outer shape of a cartridge case 2 intended for the weapon in question. After forming of the outer casing 9, this is ground to the required thickness and a loose base piece 10 (see in particular FIG. 1) is located at the rear end 5′ of the outer casing 9. Said base piece 10 is fixed to the rest of the outer casing 9 forming a tight seal by threading, adhesive bonding or by means of some other joint suited to the function and not shown in further detail. The base piece 10 can therefore be screwed out of the rest of the outer casing 9 or permanently affixed thereto. The base piece can be made of a metal, which is then suitably insulated around its peripheral part by its fixing in the insulating outer casing 9 or by a dielectric coating. The base piece is, however, preferably made of the same insulating material as the electrically insulating outer casing 9.

Said base piece 10 or the base 10′ and the plasma generator 4 bear against the block, bolt or breech 14 of the weapon, see FIG. 3, so that the plasma generator 4 is in electrical contact with a high-voltage source 13, the polarity of which can be reversed, via electrical connections 14a, 14b, comprising contact devices in the form of input and output conductors 14c, 14d. Since the cartridge case 2, that is to say the outer casing 9 and preferably also the base piece 10 or the base 10′, besides the actual plasma generator 4, also comprise or consist of one or more materials which do not conduct current or voltage to the barrel 11 and the block 14, there is therefore no or only a minimal risk that the cartridge case 2 will fuse tight in the weapon/cannon in question due to electrical short-circuiting.

It is also feasible, in an embodiment not shown, for the shrink tube to be located directly on top of the propellant charge without an inner, rigid outer casing. The shrink tube is thereby located so that it extends between the projectile and the base piece with the requisite rigidity for the ammunition function afforded by the propellant charge and/or vacuum created by the cartridge thus formed. With this embodiment, after firing such an ammunition round, only the base piece and/or the plasma generator made of metal are left, the remainder being combusted in the barrel.

In the embodiments of the ammunition round 1 shown in the drawings, see in particular FIG. 2 and FIG. 3, the projectile 3 consists of a sub-caliber, fin-stabilized armor-piercing flechette 15 with guide cone or stabilizer fins 16, the flechette 15 being at least partially enclosed in and supported inside the outer casing 9 by a multipart flechette support body referred to as a discarding sabot 17. Around the discarding sabot 17 is a band 18, designed to seal the ammunition round 1 against the inside of the barrel 11. A joint 19 in the form of a grooving, see FIG. 2, adhesive bonding etc. connects the projectile 3 to the outer casing 9 of the cartridge case 2. Armor-piercing flechette ammunition normally derives its great effect from the fact that the flechette 15 preferably has a great weight (density of approximately 17-20 g/cm³, such as tungsten, for example) and that it is fired at high velocity, so that the additional high velocity that can be achieved with the present invention constitutes a great advantage.

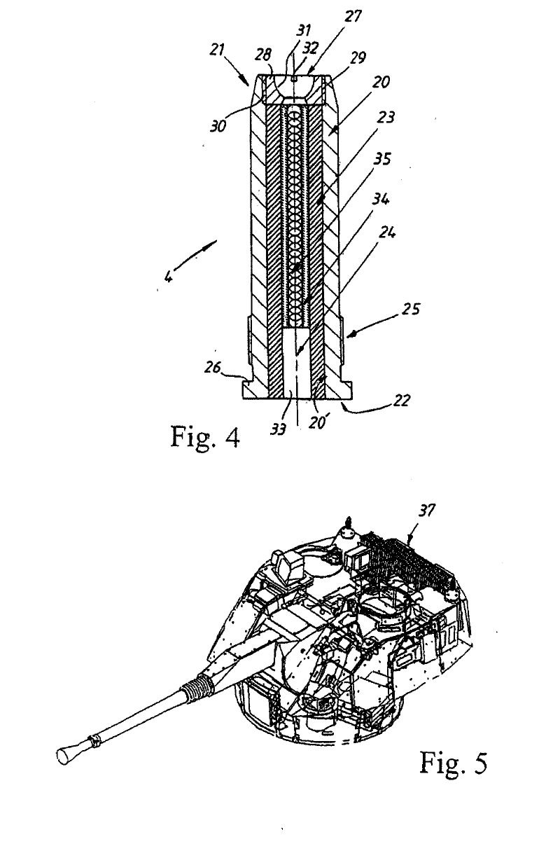

The plasma generator 4, in the embodiment shown in FIG. 4, which represents the equivalent in the ETC round 1 of a conventional primer screw, comprises an outer casing in the form of a tubular and electrically conductive, suitably metal combustion chamber 20 with a front end 21 and a rear end 22, fitted concentrically inside the central channel 20′ of the combustion chamber 20, the central channel 20′, also referred to hereinafter as the combustion chamber channel 20′, passing axially right through from end 21 to end 22, an electrical and thermal insulation in the form of a dielectric, highly heat-resistant ceramic insert, ceramic coat or other ceramic unit, preferably a ceramic tube 23, and a central electrode 24, located right at the back in the central channel 20′ and enclosed by the ceramic tube 23. The ceramic tube 23 has a heat resistance, that is to say it is designed to withstand very high temperatures without ceasing to function, up to a maximum temperature of at least 50,000° K and an operating temperature of between approximately 10,000° and 30,000° K for at least the time that the plasma is being maintained or created via fresh energy pulses and preferably at least throughout the time the projectile 3 is being propelled through the barrel 11.

Said ceramic tube 23 is fitted in place inside the combustion chamber 20 by shrinking fast, also referred to as shrink fixing, that is to say through heating up and hence expansion of the metal combustion chamber 20 and, possibly, cooling and thereby slight shrinking of the ceramic tube 23, so that an adequate tolerance is created between the combustion chamber 20 and the ceramic tube 23, so that the fitting of the ceramic tube 23 inside the combustion chamber 20 can take place despite the fact that the inside diameter of the combustion chamber 20 at normal temperature is less than the outside diameter of the ceramic tube 23. After cooling of the combustion chamber 20 to the same temperature as the ceramic tube 23, the combustion chamber 20 enclosing the ceramic tube 23 will have contracted to such a degree that not only is the ceramic tube 23 seated absolutely firmly along its entire outer surface against the inside of the combustion chamber channel 20′, so that the play occurring between the ceramic and the walls of the combustion chamber channels formed by material irregularities and tolerance defects is eliminated, possibly with a sealing compound or plastic material, for example a metallic or ceramic material, between them, spreading the load and evening out all deviations in diameter, tolerance defects and irregularities, but the ceramic tube 23 is also subject to a certain precisely defined compressive pre-stressing due to the shrinkage of the combustion chamber 20.

The compressive pre-stressing gives the ceramic tube 23 a greatly increased capacity to withstand the very high pressures and hence the tensile stresses in the ceramic material, which always occur in the formation of plasma inside the combustion chamber channel 20′. The compressive pre-stressing of the ceramic tube 23 by the combustion chamber 20 is designed so that the tensile stresses later occurring in the ceramic during the plasma formation are less than the compressive pre-stressing or are counteracted to such a degree that the resulting stresses in the ceramic are lower than the maximum permitted tensile stresses for the ceramic. The ceramic tube 23 is suitably clamped with a stressing force in the order of 300 MPa-1000 MPa, preferably 500 MPa-700 MPa. The ceramic tube 23 comprises one or more ceramic materials, preferably of titanium oxide, zirconium dioxide, aluminum oxide or silicon nitride or the like. The shrink-fixing and compressive pre-stressing of the ceramic tube 23 in the manner described above also confers several other advantageous characteristics. Shrink-fixing means that the tolerance requirement between the constituent parts is less than compared to direct assembly, in which the fit must be extremely precise, which affords considerably cheaper manufacture of the plasma generator 4, whilst also eliminating the otherwise unavoidably void which is otherwise bound to occur between the ceramic tube 23 and the combustion chamber 20. If the ceramic tube 23, due to a poor fit in relation to the combustion chamber 20, should alone be compelled to bear the internal compressive loads applied by the plasma, and the tensile stresses which would then occur in the ceramic material, the risk of fracture would increase dramatically, since ceramics normally have a tensile strength considerably lower than their compressive strength.

The plasma generator 4 is either fixed to the base 10′ integrally formed with the outer casing 9 of the cartridge case 2, see FIG. 2, or to the base piece 10 detachably arranged with the outer casing 9, see FIG. 1, the base 10′ or base piece 10 preferably being either of dielectric material or also coated with such material. For example, in the embodiment shown in FIG. 2 the combustion chamber 20 is arranged projecting from the rear end 5 of the cartridge case 2 and detachably fixed to the base 10′ by means of an external thread 25. The thread 25, see FIG. 4, is arranged adjoining the rear end 22 of the combustion chamber 20 inside a circumferential flange 26 arranged here, i.e. towards the front end 21 and projecting from the combustion chamber 20. The only parts of the ammunition round 1 behind the band 18 of the projectile 3 that are in conductive contact with the weapon, preferably consist of said flange 26 together with the metal contact device 33 of the central electrode 24, hereinafter also referred to as the central contact device. Since the band 18 may also be of plastic, the ammunition round 1 is very well electrically isolated.

A muzzle seal 27, see FIG. 4, in the form of a cylindrical body 28, functioning as a front annular electrode interacting with the central electrode 24, is located in the combustion chamber channel 20′ at the front, somewhat chamfered end 21 of the combustion chamber 4, axially outside and coaxially with the shrunk-in ceramic tube 23 and the central electrode 24. The cylindrical body 28 comprises an external thread 29 for fitting the muzzle seal 27 to the combustion chamber channel 20′ provided with a corresponding thread 30. The muzzle seal 27 further comprises a central, nozzle-shaped end orifice opening 31 passing through the cylindrical body 28, with a diameter increasing towards the front end 21 of the combustion chamber 20 for producing a plasma jet-expanding function towards the rear end of the propellant charge 6 and thereby an improved ignition and combustion of the propellant charge 6. Also shown is a groove 32 for a turning tool in the outer transverse surface of the cylindrical body 28, so that the muzzle seal 27 can easily be screwed tight to the front end 21 of the combustion chamber 20.

The central electrode 24 comprises the metal central contact device 33, which in the embodiment shown in FIG. 4 is cylindrical, for the ‘input’ electrical connection, the central contact device 33 being fitted inside the rearmost part of the ceramic tube 23 by shrink-fixing (the central contact device 33 is suitably cooled in nitrogen to −196° C., so that a sufficient temperature differential is created in relation to the ceramic tube 23 for shrink-fixing to occur), a sacrificial material 34 arranged between the central contact device 33 and the muzzle seal 27, suitably in the form of a tube, which is therefore hereinafter referred to as a sacrificial material tube 34, fixed inside and against the inside of the ceramic tube 23, and at least one, but preferably more electrical conductors 35 arranged inside the sacrificial material tube 34 and along the entire length of the sacrificial material tube 34, so that the central contact device 33 and the cylindrical body 28 are electrically connected to one another. The electrical conductor(s) 35, which have the function of a hot filament to facilitate the formation of a first electrical arc between the central contact device 33 and the muzzle seal 27 or catalyst for the plasma formation, may suitably consist of thin filaments, wool, rolled film, net structures, porous thin films etc., preferably of metal such as aluminum, copper, titanium or steel etc. Said fixing of the sacrificial material tube 34 to the ceramic tube 23 is suitably achieved by means of a suitable permanent adhesive and the fact that the sacrificial material tube 34 and the ceramic tube 23 are axially fixed and to a certain extent tensioned by screwing the cylindrical body 28 tight against their end surfaces with a certain, defined force. In order to ensure electrical contact, the threads 29, 30 may be copper-coated and the electrical conductor(s) 35 is/are firmly wedged in said threads 29, 30. The aforementioned measures also ensure that the sensitivity of the plasma generator 4 to impacts and vibrations is largely eliminated.

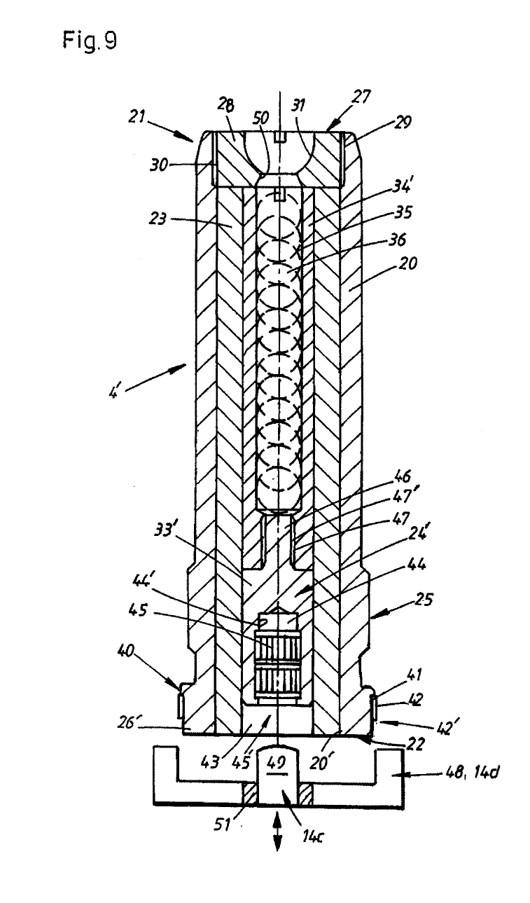

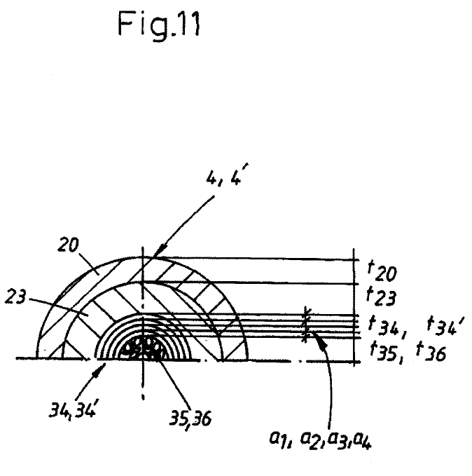

The sacrificial material tube 34 having a total thickness t₃₄, t_{34′}, see in particular FIG. 11, in which the sacrificial material tube for different parts is denoted without the ′ for the first embodiment shown in FIG. 4 and with the ′ for the second embodiment shown in FIG. 9, is intended, in a coat-by-coat combustion thereof, to be gasified one layer or surface coat a1, a2, a3, a4 at a time for each new energy pulse and thereby to give off the aforementioned ‘lighter’ molecules, atoms or ions, which generate a plasma and which facilitate the ignition and combustion of the propellant charge 6 and maintain and enable the continued plasma process even after the electrical conductors 35 have been consumed.

FIG. 11 therefore schematically shows a sacrificial material tube 34, 34′, having a certain overall thickness t₃₄, t_{34′}, where the overall tube thickness t₃₄, t_{34′} is shown divided into a number, in this case in the particular embodiments shown four, concentric theoretical surface coats or actual layers laminated on top of one another, jointly marked in both cases by a₁, a₂, a₃, a₄. As will be explained below, the number of schematically represented surface coats or layers a₁, a₂, a₃, a₄ in FIG. 11 represents either the number of surface coats that are gasified by the same number of energy pulses fired (where each of the surface coats shown also represents the surface coat thickness gasified for each specified energy pulse, and the specified energy pulse and hence also the surface coat thickness pertaining thereto may vary), or the number of actual layers and their thickness that were previously dimensioned and then combined into an estimated or calculated consumption requirement for the specified energy pulses for a certain type of ammunition round and ETC weapon.

The total thickness t₃₄, t_{34′} of the sacrificial material 34, 34′, its various part thicknesses a₁, a₂, a₃, a₄ and the choice of constituent material are therefore precisely designed and selected so that a thinner surface coat or layer a₁, a₂, a₃, a₄ can always be gasified per specified electrical energy pulse, the sacrificial material 34, 34′ being heated, gasified and ionized coat by coat or layer by layer a₁, a₂, a₃, a₄ into plasma by the very powerful, electrical energy pulse of defined duration, amplitude and shape that is triggered between the central electrode 24, 24′ and the annular electrode, that is to say the muzzle seal 27, for each such surface coat or layer a₁, a₂, a₃, a₄, so that a predetermined plasma is made to flow out through the end orifice opening 31 at a very high pressure and at a very high temperature, preferably between approximately 10,000° K and 30,000° K

The term lighter molecules and atoms here refers to molecules and atoms with a low molecular weight, preferably ≦30μ (30 g/mol), from material which in combustion forms molecules and ions which are lighter, that is to say which have a lower molecular weight, than the molecules and ions formed by the relevant electrical conductor(s) 35 and the thinner metal ions ablated from the combustion chamber channel walls in the known plasma generators and, preferably, from the combustion of the propellant charge 6. One aim of this is that the ionization should produce electrically charged molecules and/or atoms, which give an improved ignition of the propellant charge 6 and that the plasma formed should have a considerably lower sound velocity than the conventional propellant gases, which produces and advantageous accelerating effect on the projectile 3.

The sacrificial material tube 34, 34′ therefore comprises at least one sacrificial material, which at least in the plasma formed disintegrates into molecules, atoms or ions, where the sum of the atomic masses of the atoms in the disintegrated molecule (the molecular mass) is preferably lower than approximately 30μ (g/mol). Such a sacrificial material 34, 34′ suitably contains hydrogen and carbon, for example, which satisfactorily meet this condition. The sacrificial material tube 34, 34′, in the embodiments in FIG. 4 and FIG. 9 described here, consists of at least one dielectric polymer material, preferably a plastic with a high melting temperature (preferably in excess of 150° C.), a high gasification temperature (more than 550° C., preferably more than 800° C.) and a low thermal conductivity (preferably less than 0.3 W/mK). Particularly suitable plastics include thermoplastics or thermosetting plastics, for example polythene, fluoroplastics (such as polytetrafluoroethylene, etc.), polypropylene etc., or polyester, epoxy or polyimides etc. for ensuring that only one surface coat or layer a₁, a₂, a₃, a₄ of the sacrificial material is gasified for each energy pulse. The sacrificial material 34, 34′ should preferably also be sublimating, that is to say passing directly from a solid form to a gaseous form. It is also feasible to arrange layers of different material, thickness etc. to form a laminated sacrificial material, in order to produce said gasification of the laminate coat by coat a₁, a₂, a₃, a₄.

The thickness t₃₄, t_{34′} of the sacrificial material tube 34, 34′ is calculated, dimensioned and manufactured so that only the outermost surface coat or layer a₁, a₂, a₃, a₄, i.e. that is to say the exposed surface coat or layer facing outwards from the surface of the ceramic tube 23 towards the electrical conductors 35, is gasified by each electrical pulse, so that a number of pulses can be generated from the plasma generator 4, 4′ into the cartridge case 2 and further out to the barrel 11, it being possible to deliver further plasma and hence electrical energy after the first emitted plasma (see the functional description for further explanation). Even if the plasma has been allowed to cool between the energy pulses, the plasma generator 4, 4′ can still be fired and can give off new light molecules as long as the sacrificial material 34, 34′ remains. It is also worthwhile observing here that the ceramic tube 23 prevents the metal combustion chamber channel 20′ emitting ions, which is why the plasma generators that comprise a ceramic lining use a metal filament or an electrically conductive material in order to initiate the arc between the electrodes and when this filament/material has burned out and the plasma has been extinguished/spurted out of the plasma generator a new energy pulse cannot be fired. Ideally the sacrificial material 34, 34′ will only be consumed as and when the final electrical energy pulse that needs to be generated for the plasma, in order to produce the desired pressure curve inside the barrel 11, is emitted, the projectile 3 receiving the final additional energy, and thereby the final pressure increase and the final increase in acceleration at the same time as the projectile 3 leaves the muzzle of the barrel.

The fact that the sacrificial material 34, 34′ has such a high gasification temperature and such a low thermal conductivity that the chosen sacrificial material 34, 34′ is capable, despite a considerably longer pulse length, of only being gasified coat by coat or layer by layer a₁, a₂, a₃, a₄ for each new energy pulse, provides a satisfactory solution to the problem of achieving the desired, considerably longer pulse lengths, that is to say pulse lengths longer than 1-10 milliseconds, and the desired, considerably prolonged plasma lifespan without such high temperatures occurring that the plasma generator 4, 4′ is damaged despite the ceramic lining/insert. Because the sacrificial material 34, 34′ is only capable of being gasified one coat/layer a₁, a₂, a₃, a₄ at a time for each new energy pulse, the desired, considerably prolonged plasma lifespan is obtained and the temperature otherwise damaging to the plasma generator 4, 4′ is cooled by the continuous supply of light ions.

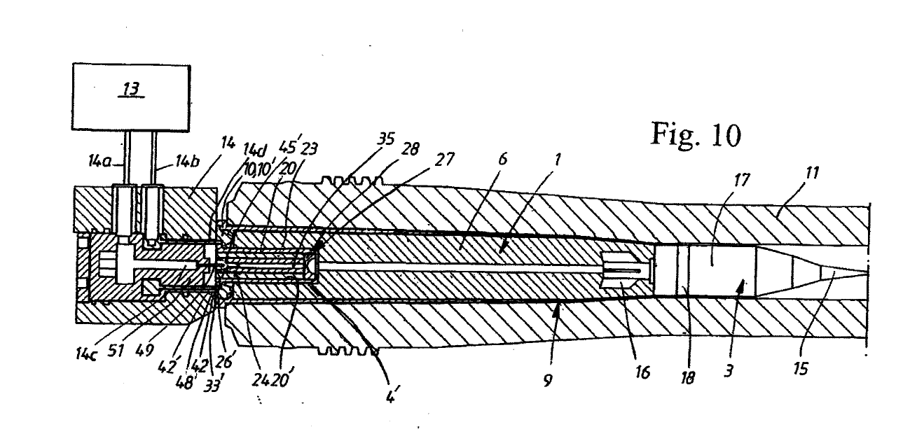

The formation of plasma from the dielectric sacrificial material 34, 34′ and the supply of electrical energy for propulsion of the projectile 3 continues throughout the propulsion sequence in that the high-voltage source (see FIG. 3 and FIG. 10, in particular) applies an electrical potential over the dielectric sacrificial material 34, 34′ via the electrodes 28, 33, 33′ (see, in particular, FIG. 4 and FIG. 9), that is to say the cylindrical body 28 and the central contact device 33, 33′, at opposite ends of the combustion chamber channel 20′. The total propulsion energy to the projectile 3 therefore receives substantial additional energy via the supply of extra electrical energy from the high-voltage source 13 through the plasma formed inside the combustion chamber 20. The quantity of plasma that spurts into the cartridge case 2 combines with the ionized propellant charge gases, so that the total quantity of plasma out in the barrel 11 increases in line with the projectile acceleration through the entire barrel 11, until the projectile 3 leaves the barrel 11, so that the gas pressure is maintained at the desired barrel pressure throughout the entire sequence.

If a closed electrical circuit is arranged between the contact device 33, 33′ of the central electrode 24, 24′ and an electrode further forward in the barrel 11, further energy can be supplied to a plasma there (not shown).

When using the invention in a combat vehicle, the high-voltage source 13 is suitably applied as a ‘buffer store’ in the turret, such as a pulse unit 37 in the form of a ‘rucksack’, see FIG. 5, which is charged prior to a salvo from a ‘main store’ located inside the actual combat vehicle.

In the second embodiment of the plasma generator 4′ according to the invention shown in FIG. 9, this second embodiment comprises substantially all the same parts, selected materials and characteristics as the first embodiment of the plasma generator 4 shown in FIG. 4 and described in the text above, including possible combinations thereof, for which reason the same reference numerals are used below, wherever possible.

The main differences which are shown in the embodiment according to FIG. 9, and which are then given a reference numeral identified by ′, are, for example, the fact that the metal combustion chamber 20 has an improved design of the flange 26′, the improved flange 26′ along its peripheral edge 40 now comprising a groove 41, in which groove 41 an outer, enclosing laminated contact strip 42 of conductive material, for example copper, is arranged, for example adhesively bonded or otherwise fixed in the groove 41. This unique design, here comprising the peripheral edge 40 with the groove 41 and the outer laminated contact strip 42 will also hereinafter be referred to for the sake of simplicity as the outer laminated contact 42′.

The outer, enclosing laminated contact strip 42, which is somewhat arched and is fitted with its convex side outwards, comprises, in relation to is longitudinal extent, transverse, evenly distributed, continuous, tight gaps for creating thin, bridge-shaped segments with resilient characteristics for producing a good contact with an interacting female contact device 48, represented schematically in FIG. 9 and FIG. 10, which is arranged in the breech 14, functioning as the output conductor 14d of the breech 14, in which female contact device 48 the flange 26′ is introduced to a certain, defined distance, preferably exceeding the flange thickness. This means that the flange 26′ with the laminated contact strip 42 and the female contact device 48 are able to move a shorter axial distance relative to one another.

The plasma generator 4′ according to this embodiment, FIG. 9, further comprises a somewhat differently designed central electrode 24′. The rear metal central contact device 33′ in FIG. 9 is shown projecting axially somewhat inside the ceramic tube 23 towards the front cylindrical body 28, a void 43 being formed towards the rear end 22 of the combustion chamber 20, the void 43 being intended for the male contact device 49 of the breech 14, that is to say the input conductor 14c (represented schematically in FIG. 9 and FIG. 10). Said central contact device 33′ additionally comprises a rear central cavity 44, which extends axially inwards, the inner surface 44′ of the cavity 44 being lined with the same type of laminated contact strip 45 and having a corresponding function and appearance to the laminated contact strip 42 of the flange 26′, but with the difference that the male contact device 49, arranged in the breech 14 and represented schematically in FIG. 9 and FIG. 10, and functioning as input conductor 14c, is introduced into said cavity. Here too, this unique design, comprising at least the rear central cavity 44 and laminated contact strip 45, but suitably also the void 43, will in this text, for the sake of simplicity and in the same way as above, also be referred to as the inner laminated contact 45′.

The central contact device 33′ in the second embodiment shown in FIG. 9 also comprises a front, threaded pin 46, on which pin 46 the sacrificial material 34′ is threaded by means of a corresponding cavity 47 having an internal thread 47′. This serves to produce a better fixing of the sacrificial material 34′ inside the combustion chamber channel 20′, since some of the plasma jets flowing out of the combustion chamber 20 otherwise risk being ‘blown’ out of the sacrificial material 34′ contained in the combustion chamber 20. For this reason the sacrificial material 34′ is also adhesively bonded to the inside of the combustion chamber channel 20′ and so arranged in relation to the cylindrical body 28 that this body 28 functions as a brace for the sacrificial material 34′ and the ceramic tube 23. In the second embodiment shown, the electrical conductors 35 can be introduced into the thread 47′ between the pin 46 and the cavity 47, so that the electrical conductors 35 are held secured inside the sacrificial material 34′. The electrical conductors 35 may also be fixed by means of a solidified plastic mass 36, which is most easily poured in a molten state into the sacrificial material tube 34′ and thereby encloses the electrical conductors 35 inside it. The sacrificial material tube 34′ can also be similarly poured in a molten state into the ceramic tube 23, solidified around the threaded pin 46 and then bored out for fitting the electrical conductors 35 and the solidified plastic mass 36. This process is repeated with multiple layers of material so as to produce the desired laminate. All said fixings of said parts serve to make the plasma generator 4′ very insensitive to vibrations, which has been a major problem in hitherto known plasma generator designs. The solidified plastic mass 36 may be composed of stearin, paraffin, glycerin, gelatin etc., for example.

Said male contact device 49 and female contact device 48 insulated 51 from one another (represented only schematically in FIG. 9 and FIG. 10) in the breech 14 and the flange 26′ (arranged in the plasma generator 4′) respectively, comprising the outer, enclosing laminated contact strip 42, and the central contact device 33′, comprising the rear central cavity 44 and the inner laminated contact strip 45, fixed to the inner surface 44′ of the cavity 44 in a manner similar to the outer laminated contact strip 42, therefore function as input conductor 14c and output conductor 14d of the weapons system, with a comparably larger contact surface than in previous design constructions, the new input conductor 14c and output conductor 14d being better able to withstand both the vibrations normally occurring, a relatively large weapon recoil, and the movement(s) occurring during the energy pulse and thereby a smaller axial displacement of the contact devices 48, 49 of the block/the breech 14 in relation to the outer and inner laminated contacts 42′, 45′ of the plasma generator 4′ at the flange 26′ and the central contact device 33′, that is to say at its outer laminated contact strip 42 and inner laminated contact strip 45, without the bearing contact and hence the electrical contact being impaired by the recoil, or in the event of other vibration or impact occurring, such impaired contact being possible where design constructions only having contacts of the spot or surface contact type are used.

With such contacts of the spot or surface contact type, the contact devices in each pair of contact devices resting against one another risk being separated somewhat from one another, partly by movement of the weapon and partly by the firing of each energy pulse, with the result that a slight play can occur between the breech contact device and the plasma generator contact device, which then produces an electrical arc, which risks fusing the contact devices together, particularly in the case of exceptionally high energy transmissions. If this fusing of the contact devices should occur, it makes it impossible to place a new ammunition round in the firing position in the block, the breech etc. In such a weapon it may therefore become difficult to fire several rounds automatically in succession over a longer period without the weapon jamming. Even with just one single energy pulse, the contact devices may fuse tight if the contact surface is too small and the energy transmission is too great. In the event of large energy transmissions, the second embodiment shown in FIG. 9 therefore copes better than the first embodiment shown in FIG. 4, for which reason the contact devices of the plasma generator 4 and the breech 14 interacting therewith in the first embodiment are suitably endowed with a somewhat rounded contact surface shape (not shown), thereby improving the capacity to perform large energy transmissions without a greater risk of fusing together.

In the second embodiment shown in FIG. 9 with the unique design of the central contact device 33′ and the flange 26′, comprising the so-called laminated contacts 42′, 45′ with the laminated contact strips 42, 45 fitted in the groove 41 and the inner surface 44′ of the rear central cavity 44, it is possible to automatically fire several ammunition rounds 1 in succession and also to fire several pulses for each such ammunition round 1, without play and the resulting arc occurring between the contact devices 48, 49 and laminated contacts 42′, 45′ of the breech 14 and the plasma generator 4′, such arcs normally exposing the contact devices 48, 49 to the risk of fusing tightly together, since the laminated contacts 42′, 45′ interacting with the contact devices 48, 49 readily cope with normal external vibrations, recoil and the other vibrations that occur, in the barreled weapon in question when the plasma generator 4′ is used.

One difference in the design of the laminated contacts 42′, 45′ shown in FIG. 9 compared to the first embodiment shown in FIG. 4 is that the laminated contact strips 42, 45 in FIG. 9 allow the contact devices 48, 49 and the laminated contact strips 42, 45 scope to slide a certain axial distance relative to one another and to still be in firm contact, thanks to the slide surface on each part interacting between them. This design of the contact surface naturally produces a larger contact surface than in the usual spot or surface contact type, so that the current transmission is distributed over this larger contact surface, thereby facilitating the current transmission and eliminating the risk of arcing, which prevents fusing/burning together even under several pulses.

Functional Description

The manufacture, function and use of the plasma generator 4, 4′ according to the invention are as follows. Compare FIG. 3 and FIG. 4 for the aforementioned first embodiment with FIG. 9 and FIG. 10 for the second embodiment described.

In order to fit the ceramic tube 23 inside the metal combustion chamber 20, the combustion chamber 20 is first heated to approximately 550° C., following which the ceramic tube 23, which may be cooled but not to such an extent that it becomes brittle, is inserted into the combustion chamber channel 20′. When the combustion chamber 20 and the ceramic tube 23 have reached the same temperature, the combustion chamber 20 will have shrunk more than the outside diameter of the ceramic tube 23 at this temperature, so that the ceramic tube 23 is subjected to compressive pre-stressing by the combustion chamber 20. The greater the difference in diameter between the outside diameter of the ceramic tube 23 and the diameter of the combustion chamber channel 20′, the greater the compressive pre-stressing. The desired compressive pre-stressing in the ceramic tube 23 can thereby be both calculated and achieved.

Similarly the central contact device 33, 33′ (suitably cooled in nitrogen to −196° C.) is inserted inside the ceramic tube 23, and after returning to normal temperature the central contact device 33, 33′ will have expanded to such a degree that it is securely fixed inside the ceramic tube 23.

The sacrificial material 34, 34′ is applied either by bonding it in the form of a tube, or by pouring it in liquid form down into the ceramic tube 23, following which the sacrificial 34, 34′ is suitably bored out to receive the electrical conductors 35, which are suitably jammed in the thread 29, 30 when the cylindrical body 28 is screwed tight. This provides a plasma generator very insensitive to vibrations. In the second embodiment, shown in FIG. 9, this has been further improved in that an adhesive-coated sacrificial material tube 34′ is inserted into the ceramic tube 23 and screwed tight to the threaded pin 46. The electrical conductors 35 are suitably jammed in the thread 47′ when the central contact device 33′ is screwed tight to the threaded pin 46. The sacrificial material tube 34, 34′ is suitably locked tight by the cylindrical body 28, since the nozzle opening 50 of the cylindrical body 28 inside the combustion chamber 20 is smaller than the diameter of the sacrificial material tube 34, 34′. The laminated contact strips 42, 45 are then fixed both in the groove 41 in the flange 26′ and inside the rear central cavity 44 in the central contact device 33′. After being screwed tight to the base 10′ or base piece 10 of the cartridge case 2, the result is an ammunition round 1 ready for firing, which can be loaded in the ETC weapon in question. It will be appreciated that the plasma generator 4, 4′ according to the invention can also be applied in a caseless round, that is to say one in which cartridges and projectile are arranged directly in the barrel without a cartridge case, for example only enclosed in the aforementioned shrink-tube 12.

In firing an ammunition round 1, see FIG. 3 and FIG. 10, situated in the breech block/bolt/breech 14 of the weapons system in question, the high-voltage source 13 is connected only via the input conductor 14c and output conductor 14d of the electrical connections 14a, 14b, that is to say via the contact devices 48, 49 of the breech 14 and, in the first embodiment shown in FIG. 3 and FIG. 4, via the contact device 33 of the central electrode 24 and the flange 26 of the combustion chamber 20, or, in the second embodiment shown in FIG. 9 and FIG. 10, via the laminated contact 42′ of the flange 26′ and the laminated contact 45′ of the central contact device 33′.

Other weapon parts are suitably thoroughly isolated from all contact with the plasma generator 4, 4′. All unwanted application of current to the weapon is therefore effectively prevented. The central contact device 33, 33′ and the muzzle seal 27 function as an anode and a cathode respectively, at opposite ends of the combustion chamber channel 20′, which are electrically connected to one another by the electrical conductor(s) 35 between them. Electricity is transmitted solely via the rear end 22 of the plasma generator 4, 4′.

The current/voltage take the easiest path through the plasma generator 4, 4′, that is to say initially from the input conductor 14c and, in the first embodiment in FIG. 3 and FIG. 4, the contact device 33 of the central electrode 24, or in the second embodiment in FIG. 9 and FIG. 10, the inner laminated contact 45′ comprising the rear central cavity 44 and the laminated contact strip 45, via the electrical conductors 35 to the cylindrical body, that is to say the annular electrode 28, and then after combustion of the electrical conductors 35 via the extremely hot plasma formed, which has a very high electrical conductivity due to the ionization of the molecules and atoms, the molecules, atoms and ions being formed by gasification of the combustible constituent parts of the central electrode 24, 24′, that is to the sacrificial material tube 34, 34′ and the electrical conductors 35, following which the current/voltage is returned to the base 10′ or base piece 10 of the cartridge case 2 via the outer casing of the metal combustion chamber 20 to the flange 26 on the rear part 22 of the combustion chamber 20 and the electrical output conductor 14d located there, in the case of the first embodiment in FIG. 3 and FIG. 4, or the outer laminated contact 42′, comprising the peripheral edge 40 with groove 41 and the outer laminated contact strip 42, in the case of the second embodiment in FIG. 9 and FIG. 10. The construction of the plasma generator 4, 4′ described provides a closed vessel for the plasma until the plasma jet is formed, which prevents short-circuiting of the process. Said return of the electricity is obviously facilitated if the cartridge case 2 and preferably also the base 10′ or the base piece 10 comprise or consist of an electrically insulating material, such as said glass fiber-reinforced wrapping epoxy or plastic film coating. The barrel 11 therefore does not become live, whilst the risk of arcing/short circuit will be very substantially reduced or entirely eliminated.

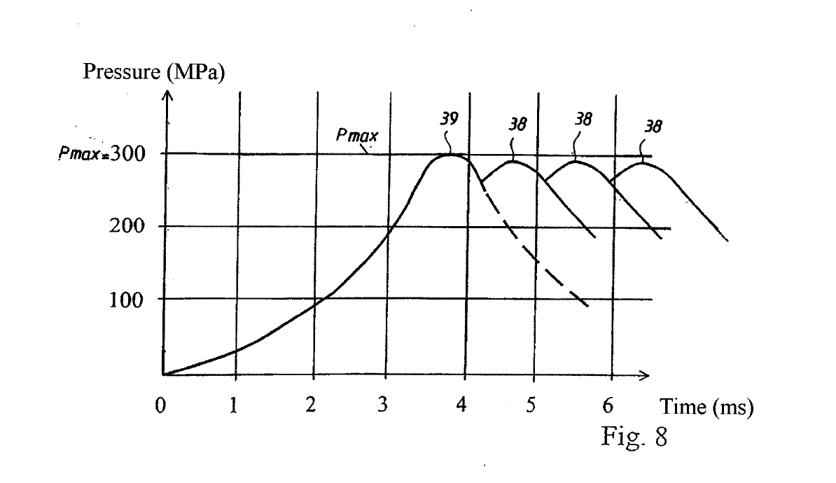

In firing, the high-voltage source 13, for example said pulse unit 37 (FIG. 5) is made to emit at least one powerful energy pulse, but preferably a number of energy pulses having a high current strength and/or a high voltage, both with a certain defined amplitude and length adapted according to the characteristics of the weapon, round, target, environment, etc. in question. In order to produce an effective plasma, for example in the case of an intermediate caliber weapon (40 mm), each energy pulse should exceed 10 kJ and should be delivered to the plasma with a pulse length of one or a few milliseconds (see FIG. 8, in particular). Where a pulse unit is used, this comprises capacitors for emitting a voltage of approximately 5-50 kVolt. The current strength may be between 5 and 100 kA, in future also more than 100 kA, for which reason it will be appreciated that the risk of personal injury is high if an unwanted arc-over should occur, rendering the barrel 11 live.

The powerful energy pulse or pulses, preferably approximately 1-6 energy pulses, heat up the electrical conductor(s) 35 to such a high temperature that they melt, are gasified and finally ionized in an arc to a very hot first plasma, which initially therefore substantially comprises only heavier metal ions from said electrical conductors 35. The heat from this first plasma then in turn gasifies and ionizes an outermost surface coat/layer of the sacrificial material tube 34, 34′, so that the ions and molecules in this surface coat/layer are mixed with the first plasma to form a second, mixed plasma comprising even lighter ions and molecules, and which second plasma is made, due to the high pressure that is built up inside the ceramic tube 23 and the sacrificial material tube 34, 34′ on ionization by means of the continuously or intermittently emitted energy pulses, to spurt out through the end orifice opening 31 in the cylindrical body 28 into the cartridge case 2 in the form of a plasma jet. The interval between the energy pulses, the pulse length, the current strength, the voltage and the additional energy can be varied according to prevailing conditions etc., and for particular characteristics of the actual weapons system and type of ammunition or projectile and the type of target in question, including the range of said target.

One object of the sacrificial material tube 34, 34′ is therefore that this, on ionization, should emit electrically charged and therefore electrically conductive particles, compounds, molecules and/or atoms, that is to say ions, which are lighter than those obtained by ionization of the electrical conductors 35, so that, among other things, an improved ignition of the propellant charge 6 is obtained. This makes it possible, with the aid of the plasma generator technique shown here, to achieve a precisely timed ignition of the ammunition round. It is furthermore possible to compensate by way of temperature for all or parts of the deterioration in pressure that occurs when an ambient temperature is colder than normal and also to reduce the maximum pressure safety margin when designing the barrel.

The aforementioned advantages are achieved because the surface coats or layers a1, a2, a3, a4 of the sacrificial material tube 34, 34′ give off molecules, atoms and ions which are lighter than the heavier metal ions that are formed from the electrical conductors 35 and because the advantageous characteristics of the plasma in question are substantially maintained between the energy pulses, since it does not extinguish or die down to a level unfavorable to the ignition and combustion of the propellant charge. In addition, the various electrical energy pulses will gradually have an effect on the electrical conductors 35, the inner sacrificial material tube 34, 34′ and the plasma formed. For example, the first energy pulse may produce a gasification and ionization of at least the electrical conductor(s) 35, preferably also a first surface coat/layer a1 from the sacrificial material tube 34, 34′, and an ignition including the incipient gasification of the propellant charge 6 and an ionization of the propellant gases formed by this, following which the succeeding electrical energy pulses may in turn gasify and ionize further thin surface coats/layers a2, a3, a4 of the sacrificial material tube 34, 34′, and maintain the plasma already formed and a continued ionization to plasma of the newly formed quantities of propellant gas from the ongoing combustion of the propellant charge 6 throughout the entire propulsion through the barrel 11, without any electrical short circuit or return from plasma to the gaseous state occurring. The desired quantity of electrical energy is supplied to the plasma by virtue of its electrical conductivity, the energy being supplied via one or more electrical pulses of defined wave form and duration, so that the barrel pressure is maintained at the optimum level for the firing in question throughout the propulsion of the projectile 3 through the entire length of the barrel.

This is due, among other things, to the fact that the propellant charge 6 is burned much more effectively by the pulsed plasma jet and the additional energy supplied etc. as has been explained above. One or more further pressure increases 38, see FIG. 8, will be obtained, one for each further energy pulse, in excess of the pressure maximum 39, see FIG. 8, showing 300 MPa as an example of Pₘₐₓ, which is obtained with a comparable conventional ignition. In firing an ammunition round 1, the individual pressure curves 38, 39, derived from each of the electrical pulses applied, suitably overlap one another, so that the overall pressure curve that is obtained for the barrel 11 in question is always just under the maximum permitted barrel pressure, whilst the pressure troughs of the overall pressure curve are minimized.

There are two main methods of implementation for burning down the sacrificial material coat by coat or layer by layer a1, a2, a3, a4.

Firstly, the coat-by-coat a1, a2, a3, a4 burn-down can be done on the basis of the additional energy and, if required and suitable, detected via appropriate sensors at the instant of the energy pulse, in order to compensate for the relevant pressure reduction in the barrel at said instant. The gasified surface coat thickness a1, a2, a3, a4 then corresponds to the additional energy required to return to Pₘₐₓ.

The second method of implementation is to build up the sacrificial material in defined layers a1, a2, a3, a4 beforehand on the basis of the weapon, ammunition, target etc., having regard to the material and desired characteristics, so that each such layer a1, a2, a3, a4, under an energy pulse specific thereto at a certain predefined pulse interval, gives the required additional energy for maintaining Pₘₐₓ, that is to say the thickness of the layers a1, a2, a3, a4 is determined at the point in time for the energy pulses fired with a certain interval, so as to produce a pre-estimated pressure increase to Pₘₐₓ.

### Exemplary Embodiments

In various exemplary embodiments of a plasma generator according to the invention, intended for a 40 mm ammunition round, ceramic tubes with an outside diameter of approximately 14-20 mm and a tube thickness of approximately 2-6 mm are used, together with sacrificial material tubes of different polymer materials and thicknesses arranged in these ceramic tubes. Said sacrificial material tubes were here specially dimensioned to thicknesses of approximately 1-6 mm, so that a coat-by-coat gasification of the sacrificial material tube was achieved under a number of successively fired energy pulses of approximately 10-100 kJ with lengths of one to a few milliseconds per pulse and with a voltage of up to approximately 50 kVolt. The current source was normally of between 5 and 100 kA, but even more than 100 kA is feasible, and a barrel pressure of approximately 400-500 MPa was attained, which was maintained more or less continuously during the propulsion sequence.

### Alternative Embodiments

The invention is not limited to the particular embodiments shown but can be modified in various ways without departing from the scope of the patent claims.

It will be appreciated, for example, that the number, size, material and shape of the constituent elements and parts of the ammunition round and the plasma generator can be adapted according to the weapons system(s) and other design characteristics prevailing in each individual case.

It will be appreciated that the ETC ammunition described above may comprise many different dimensions and projectile types, depending on the sphere of application and the barrel width. The above does relate, however, at least to the currently most common types of ammunition of between approximately 25 mm and 160 mm.

In the embodiments described above the plasma generator comprises only one front opening for one plasma jet, but arranging a plurality of such openings along the surface of the combustion chamber falls within the idea of the invention.

Besides the electrically insulated cartridge case it is also feasible to provide a further insulation of the actual plasma generator by means of a non-conductive material, which is applied to the outside of the combustion chamber.

The invention described above can also be configured for possible use with automatic fire, both by designing the plasma generator with two separate contact devices/surfaces for direct electrical connection of each individual ammunition round to the weapons system in question via its breech, and arranging corresponding contact devices/surfaces in the wedge-type breech block, that is to say the block that provides bracing when firing the round and which bears directly against the base of the ammunition round in the breech block.

1. A plasma generator for electrothermal and electrothermal-chemical weapons systems, the plasma generator being intended, via at least one emitted energy pulse, to form a plasma, which is designed to accelerate a projectile along the barrel of the weapons system in question, the plasma generator comprising a combustion chamber having an axial combustion chamber channel and a ceramic arranged inside the combustion chamber channel for insulating the combustion chamber, characterized in that, the ceramic consists of a shrink-fixed, coinpressively pre-stressed ceramic tube.

2. The plasma generator as claimed in claim 1, wherein the inside diameter of the combustion chamber is smaller than the outside diameter of the ceramic tube when the combustion chamber and the ceramic tube are at the same temperature.

3. The plasma generator as claimed in claim 1, wherein a material is located between the ceramic tube and the walls of the combustion chamber channel for evening out material irregularities, tolerance defects and other deviations in diameter occurring between the ceramic tube and the walls of the combustion chamber channel.

4. The plasma generator as claimed in claim 1, wherein the ceramic tube has a compressive pre-stressing which is greater than the tensile stresses occurring in the ceramic during plasma formation, or that the compressive pre-stressing is at least equal to such a large proportion of the tensile stresses that occur in the ceramic tube during formation of said plasma by the plasma generator that the highest tensile stresses resulting in the ceramic tube are lower than the maximum permitted tensile stress for the ceramic tube.

5. The plasma generator as claimed in claim 1, wherein the ceramic tube is shrink-fixed with a compressive pre-stressing in the order of 300 MPa-1000 MPa, preferably 500 MPa-700 MPa.

6. The plasma generator as claimed in claim 1, wherein the ceramic tube has a heat resistance which will withstand a top temperature of up to at least approximately 50,000° K and an operating temperature of between approximately 10,000° and 30,000° K, where the operating temperature acts at least during the time that the plasma is being maintained or created via fresh energy pulses.

7. The plasma generator as claimed in claim 1, wherein the ceramic tube will withstand temperatures up to at least approximately 10,000°-30,000° K at least throughout the time the projectile is being propelled through the barrel.

8. The plasma generator as claimed in claim 1 one of the preceding claims, wherein the ceramic tube comprises one or more ceramic materials, preferably of titanium oxide, zirconium dioxide, aluminum oxide or silicon nitride or the like.

9. The plasma generator as claimed in claim 1, wherein the plasma generator has an electrically conductive central electrode arranged inside the ceramic tube between the front end and the rear end of the combustion chamber, the central electrode comprising an electrically conductive central contact device, at least one electrical conductor and at least one gasifiable polymer sacrificial material, preferably containing hydrocarbons.

10. The plasma generator as claimed in claim 9, wherein the sacrificial material consists of a tube, which is arranged along a defined part of the central electrode.

11. The plasma generator as claimed in claim 1, characterized in that the sacrificial material tube is fixed to the ceramic tube by means of an adhesive.

12. The plasma generator as claimed in claim 9, wherein the central contact device is fitted inside the rear part of the ceramic tube by shrink-fixing.

13. The plasma generator as claimed in claim 12, characterized in that the outside diameter of the central contact device is greater than the inside diameter of the ceramic tube when the central contact device and the ceramic tube are at the same temperature.

14. The plasma generator as claimed in claim 1, wherein at least one gasifiable polymer sacrificial material has a lower molecular mass than said electrical conductor, this minimum of one gasifiable polymer sacrificial material preferably having a molecular mass which is <30μ (30 g/mol).

15. The plasma generator as claimed in claim 1, wherein the plasma generator comprises an axially arranged end orifice opening for delivering a single axial plasma jet out of the combustion chamber of the plasma generator.

16. The plasma generator as claimed in claim 15 in combination with claim 9, wherein the ceramic tube and the sacrificial material are axially fixed and axially clamped in the combustion chamber channel by a body comprising the end orifice opening.

17. The plasma generator as claimed in claim 15, wherein the ceramic tube and the sacrificial material are axially fixed and axially clamped by the cylindrical body screwed tight against their front end surfaces with a certain defined force.

18. The plasma generator as claimed in claim 1, wherein the plasma generator comprises multiple openings arranged radially along the circumferential surface of the combustion chamber for a radial emission of plasma jets from the combustion chamber of the plasma generator.

19. A method of fixing a ceramic in a plasma generator for electrothermal and electrothermal-chemical weapons systems, the plasma generator being intended, via at least one emitted energy pulse, to form a plasma, which accelerates a projectile along the barrel of the weapons system in question, the plasma generator comprising a combustion chamber having an axial combustion chamber channel and a ceramic arranged inside the combustion chamber channel for insulating the combustion chamber, wherein a ceramic tube is fitted inside the combustion chamber by shrink-fixing, the metal combustion chamber being heated and thereby expanded so that an adequate tolerance is created between the combustion chamber and the ceramic tube, so that the ceramic tube can be fitted inside the combustion chamber, that the combustion chamber as it cools to the same temperature as the ceramic tube shrinks around the ceramic tube and encloses the ceramic tube, so that the ceramic tube is firmly seated along its outer surface against the inside of the combustion chamber channel, and that the ceramic tube thereby acquires a certain, defined compressive pre-stressing due to the shrinkage of the combustion chamber.

20. The method of fixing a ceramic in a plasma generator for electrothermal and electrothermal-chemical weapons systems as claimed in claim 19, wherein the ceramic tube is cooled before fitting in the combustion chamber channel.

21. The method of fixing a ceramic in a plasma generator for electrothermal and electrothermal-chemical weapons systems as claimed in claim 19, wherein the ceramic tube is compressively pre-stressed by the contraction of the enclosing combustion chamber as it shrinks, so that the tensile stresses later occurring in the ceramic during the plasma formation are less than the compressive pre-stressing or are counteracted to such a degree that the resulting stresses in the ceramic are lower than the maximum permitted tensile stresses for the ceramic.

22. The method of fixing a ceramic in a plasma generator for electrothermal and electrothermal-chemical weapons systems as claimed in claim 1, wherein a central contact device is cooled, preferably in nitrogen, to −196° C., and is fitted inside the ceramic tube, and that the central contact device after it has returned to normal temperature is expanded to such a degree that the central contact device is fixed inside the ceramic tube.

23. An ammunition round comprising a plasma generator for electrothermal and electrothermal-chemical weapons systems, the plasma generator being intended, via at least one emitted energy pulse, to form a plasma, which is designed to accelerate a projectile along the barrel of the weapons system in question, the plasma generator comprising a combustion chamber having an axial combustion chamber channel and a ceramic arranged inside the combustion chamber channel for insulating the combustion chamber, wherein the ammunition round comprises a plasma generator according to claim 1.

24. An ammunition round comprising a plasma generator for electrothermal and electrothermal-chemical weapons systems, the plasma generator being intended, via at least one emitted energy pulse, to form a plasma, which is designed to accelerate a projectile along the barrel of the weapons system in question, the plasma generator comprising a combustion chamber having an axial combustion chamber channel and a ceramic arranged inside the combustion chamber channel for insulating the combustion chamber, wherein the ammunition round comprises a plasma generator manufactured by a method according to claim 1.
